(19) United States
(12) Patent Application Publication
(10) Pub. No.: US 2006/0130932 A1
(43) Pub. Date: Jun. 22, 2006

(54) Pencil sharpener

(76) Inventors: Heng-Fu Chen, Taipei City (TW); Ming-Kune Yang, Taipei City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 11/256,083

(22) Filed: Oct. 24, 2005

(30) Foreign Application Priority Data
Dec. 16, 2004 (TW) 093220266

(51) Int. Cl. B43L 23/02; B43L 23/00

(52) U.S. Cl. 144/28.4; 144/28.72; 144/28.6

(57) ABSTRACT

The present invention discloses a pencil sharpener that includes a sharpening module having a sharpening section disposed in a casing, a sharpening hole and a sharpening knife disposed on the sharpening section and driven by a motor, and a power accessing component having a USB power connector and connected with the motor by a circuit.

### BACKGROUND OF THE INVENTION

1. Field of the Invention

The present invention relates to a pencil sharpener, and more particularly to a pencil sharpener that obtain electric power from a universal serial bus (USB) output device.

2. Description of the Related Art

Pencil sharpener is common stationery used in many occasions, particularly by draftmen or students, and pencil is indispensable stationery. Even there exist various different kinds of writing instruments nowadays, the use of pencils is still very popular.

In general, the use of a pencil requires a pencil sharpened to cut away the wooden part of the pencil to expose the lead, and thus the pencil sharpener has been introduced to the market years ago. The development of the pencil sharpener changes from the traditional manual way to the use of AC or DC power.

As to a power pencil sharpener, it is necessary to change batteries and thus is inconvenient for its use. If AC is used for the power, a power socket is needed for obtaining the electric power, which is also inconvenient for its use.

Since appliances are usually used and gathered at a place, such as cooking devices are used in a kitchen, a pencil is generally used in a writing environment.

### SUMMARY OF THE INVENTION

In view of the foregoing shortcomings of the prior art pencil sharpeners, the inventor of the present invention based on years of experience in the related industry to conduct extensive researches and finally invented a pencil sharpener in accordance with the present invention.

It is a primary objective of the present invention to provide a pencil sharpener that comprises a sharpening module 1 and a power accessing component 2 connected to the sharpening module 1.

### BRIEF DESCRIPTION OF THE DRAWINGS

FIG. 1 is a schematic view of a pencil sharpener of the present invention; and

FIG. 2 is a cross-sectional view of a pencil sharpener of the present invention.

### DETAILED DESCRIPTION OF THE PREFERRED EMBODIMENTS

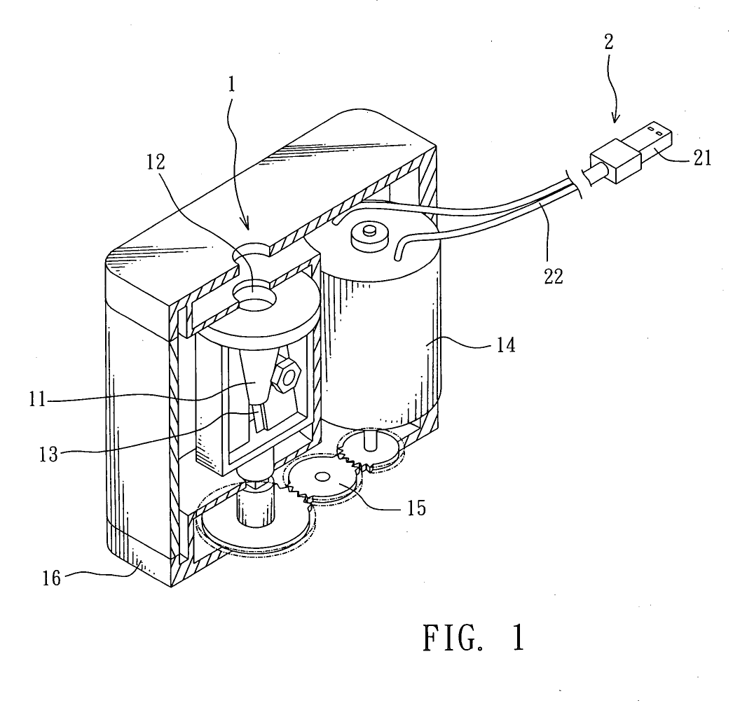

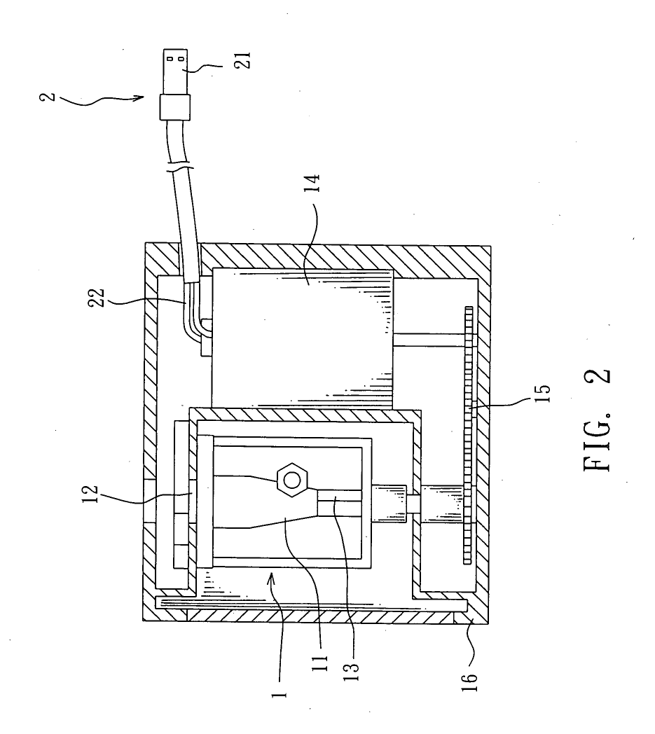

Referring to FIGS. 1 and 2, the sharpening module 1 is a prior art that includes a sharpening section 11, and the sharpening section 11 includes a sharpening hole 12 and a sharpening knife 13 disposed at the top of the sharpening section 11 and driven by a gear of a motor 14. A reducer gear 15 is connected to the motor to improve the torque. The sharpening module 1 is a prior art structure used for the current electric pencil sharpener, and thus will not be described here.

The power accessing component 2 comprises a USB connector 21 coupled to the motor 14 by a circuit 22 for accessing electric power, and the USB connector 21 is used since computer is very popular and a USB slot is generally reserved for use by users. Therefore, it is very convenient to access electric power through the USB slot. The power supplied by the USB slot is generally 5V which is used as the power supply of the pencil sharpener. If the output speed of the motor 14 is too fast, a reducer gear 15 can be added to increase the torque.

Referring to FIGS. 1 and 2 for the use of the pencil sharpener according to a preferred embodiment of the present invention, the USB connector 21 of the power accessing component 2 is plugged into a computer (including a notebook computer) or a USB slot of other appliances to access power and sharpen a pencil, and such use is very convenient.

To add more fun to the pencil sharpener, the power accessing component 2 includes a sound device synchronously connected with the sharpening module 1 for playing music or IC driven audio output and/or a light device such as an blinking LED, so that the pencil sharpener can achieve the sound and/or light effects when a user operates the pencil sharpener according to the present invention. Since the sound and light devices are prior arts that can be achieved easily by those skilled in the art, and thus will not be described here.

In summation of the above description, the present invention herein complies with the patent application requirements and is submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pencil sharpener, comprising:
a sharpening module, having a sharpening section disposed in a casing, and a sharpening hole and a sharpening knife disposed on said sharpening section and driven by a motor; and
a power accessing component, having a USB power connector coupled with said motor by a circuit.

2. The pencil sharpener of claim 1, wherein said casing includes a detachable part.

3. The pencil sharpener of claim 1, wherein said motor is coupled to a reducer gear.

4. The pencil sharpener of claim 1, further comprising a sound device coupled to said sharpening module.

5. The pencil sharpener of claim 1, further comprising a light device coupled to said sharpening module.
